(19) United States
(12) Patent Application Publication
(10) Pub. No.: US 2010/0134685 A1
(43) Pub. Date: Jun. 3, 2010

(54) DIGITAL IMAGE PROCESSING DEVICE

(76) Inventors: Kazuo Nakamura, Osaka (JP); Shingo Miyauchi, Osaka (JP)

Correspondence Address: MCDERMOTT WILL & EMERY LLP, 600 13TH STREET, NW, WASHINGTON, DC, 20005-3096, US

(21) Appl. No.: 12/595,000

(22) PCT Filed: Sep. 11, 2008
(86) PCT No.: PCT/JP2008/002522

§ 371 Date: Oct. 7, 2009

(30) Foreign Application Priority Data
Sep. 18, 2007 (JP) 2007-242196

(51) Int. Cl. H04N 5/50

(52) U.S. Cl. 348/569; 348/E05.097

(57) ABSTRACT

A digital image processing device in which the transfer data amount is reduced and a plurality of OSD images are superimposed on video includes: a sequencer configured to overlay a plurality of OSD images on each other considering their priorities and store a resultant synthesized image in a work memory; a switch signal generation section configured to generate a switch signal indicating which pixel among pixels of the plurality of OSD images should be displayed as a pixel of the synthesized image based on coordinate data indicating regions in which the plurality of OSD images are displayed and the priorities of the plurality of OSD images; and a conversion section configured to store lookup tables each indicating the relationship between index data and data representing a color corresponding to the index data, convert index data of the synthesized image read from the work memory to data representing a corresponding color using the lookup table corresponding to the switch signal, and output the resultant data.

### TECHNICAL FIELD

The present invention relates to a digital image processing device for on screen display (OSD).

### BACKGROUND ART

In recent years, digitization of TV broadcasts is in progress in many countries in the world, whereby enjoying high-definition, high-quality video at home has become increasingly popular. Digital broadcast receivers however have a problem of being high in production cost because large-scale signal processing is necessary for such receivers.

One of factors responsible for the increased cost is a large-capacity memory used as a work memory for a video signal processing LSI. To receive a high-definition, high-quality digital broadcast, the transfer data amount per unit time (memory bandwidth) must be increased between a work memory and a signal processing LSI. For this, a number of high-speed work memories must be mounted. In this regard, if the memory bandwidth can be reduced, the number of work memory components will be able to be reduced, or an inexpensive work memory comparatively slow in operation speed will be able to be adopted.

One of causes of access to a work memory is OSD. OSD images include ones transmitted by being multiplexed with a broadcast wave as data of a data broadcast and ones unique to individual TV receivers such as an electronic program guide (EPG) and a channel banner. Such OSD images are normally superimposed on transmitted video to be displayed on a screen. In particular, OSD images unique to TV receivers, which are used as a user interface, have been increasingly used to display distinctive images for individual assembly manufacturers as one of differentiation techniques.

Display of a plurality of OSD images has been becoming popular. Patent Document 1 below discloses an example of the technique for this display.

### Patent Document 1: Japanese Laid-Open Patent Publication No. 2000-305549

### Patent Document 2: Japanese Laid-Open Patent Publication No. 61-133983

### DISCLOSURE OF THE INVENTION

### Problems to be Solved by the Invention

However, Patent Document 1 described above has the following problems. Since bit streams of a plurality of OSD images are read from a work memory in parallel, the transfer data amount per unit time from the work memory is large. Also, since a plurality of lookup tables are used in parallel at all times, power consumption is large. Moreover, processing of video and processing of the OSD images must be made simultaneously in synchronization with video output. This is not suited to processing by a processor.

Patent Document 2 describes switching of lookup tables but does not specify synthesis of OSD images. In readout of pixel data included in a plurality of OSD images in order of display of a synthesized OSD image, real-time access to memory addresses at random positions is necessary. This makes the memory access complicate, and hence it is disadvantageously difficult to perform burst transfer like one generally used for transfer of image data.

An object of the present invention is reducing the transfer data amount per unit time read from a work memory and yet superimposing a plurality of OSD images on inputted video.

### Means for Solving the Problems

The digital image processing device of an exemplary embodiment of the present invention includes: a sequencer configured to overlay a plurality of OSD images on each other considering their priorities and store a resultant synthesized image in a work memory; a switch signal generation section configured to generate a switch signal indicating which pixel among pixels of the plurality of OSD images should be displayed as a pixel of the synthesized image based on coordinate data indicating regions in which the plurality of OSD images are displayed and the priorities of the plurality of OSD images; and a conversion section configured to store lookup tables each indicating the relationship between index data and data representing a color corresponding to the index data, convert index data of the synthesized image read from the work memory to data representing a corresponding color using the lookup table corresponding to the switch signal, and output the resultant data.

With the above configuration, a synthesized image is obtained from a plurality of OSD images and conversion is made for index data of the synthesized image using an appropriate lookup table. Hence, in display of the plurality of OSD images overlaid on each other, the transfer data amount can be reduced.

### EFFECT OF THE INVENTION

According to an exemplary embodiment of the present invention, the transfer data amount per unit time read from the work memory can be reduced, and a plurality of OSD images can be displayed by superimposing them on inputted video. This permits a wide variety of display with a plurality of OSD images while minimizing the cost of the work memory.

### BRIEF DESCRIPTION OF THE DRAWINGS

FIG. 1 is a block diagram of a digital image processing device of an embodiment of the present invention.

FIG. 2 is a view illustrating an example of OSD images represented by index data stored in a work memory in FIG. 1.

FIG. 3 is a view illustrating generation of an LUT switch signal.

FIG. 4 is a block diagram of a first alteration of the digital image processing device of FIG. 1.

FIG. 5 is a block diagram of a second alteration of the digital image processing device of FIG. 1.

FIG. 6 is a block diagram of a third alteration of the digital image processing device of FIG. 1.

FIG. 7 is a view illustrating an example of OSD images stored in a work memory in FIG. 6.

### DESCRIPTION OF REFERENCE CHARACTERS

32 Sequencer
34 CPU
35, 435 Conversion section
36A, 36B, 36C, 36D LUT memory
38, 438 Multiplexer
44 Region selection register
45, 245, 345, 445 Switch signal generation section
46 Region selection signal generation section
48, 248, 348, 448 Decoder
252 LUT allocation register
354 Region priority selection register
456 Pixel information register

### BEST MODE FOR CARRYING OUT THE INVENTION

Hereinafter, an embodiment of the present invention will be described with reference to the relevant drawings.

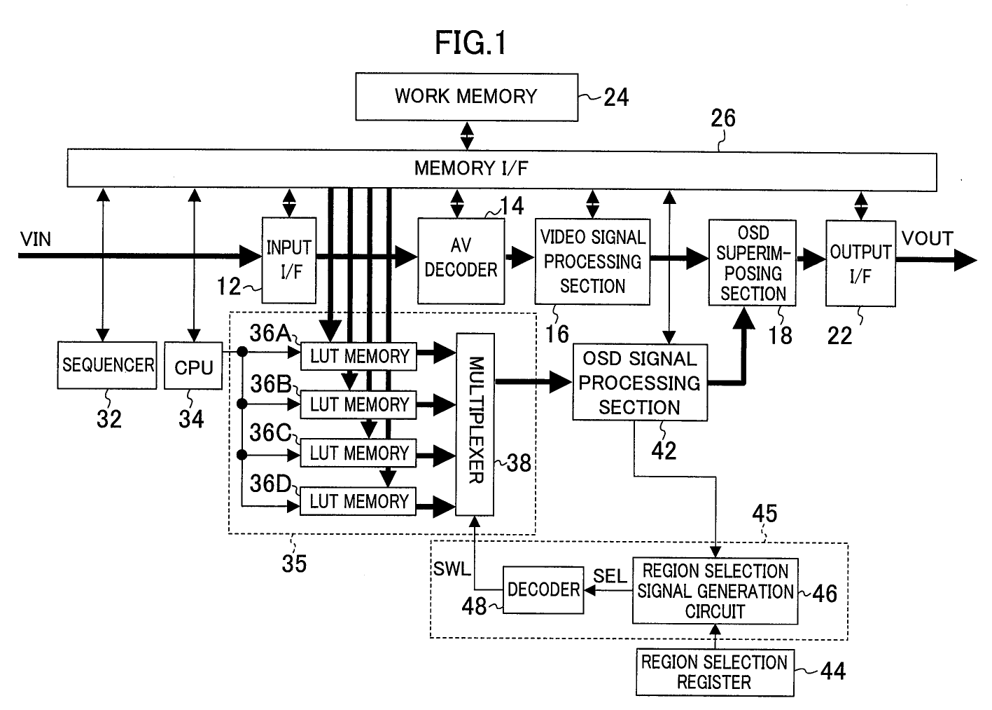

FIG. 1 is a block diagram of a digital image processing device of an embodiment of the present invention. The digital image processing device of FIG. 1 includes an input interface (I/F) 12, an AV decoder 14, a video signal processing section 16, an on screen display (OSD) superimposing section 18, an output interface 22, a memory interface 26, a sequencer 32, a CPU 34, memories 36A, 36B, 36C and 36D for lookup tables (LUTs), a multiplexer 38, an OSD signal processing section 42, a region selection register 44, a region selection signal generation circuit 46 and a decoder 48. The LUT memories 36A to 36D and the multiplexer 38 constitute a conversion section 35. The region selection signal generation circuit 46 and the decoder 48 constitute a switch signal generation section 45.

Assume herein that an input video signal VIN is a transport stream. The input interface 12 performs processing such as conversion of the stream type for the input video signal VIN and outputs the results to the AV decoder 14. The AV decoder 14 performs MPEG (Moving Picture Experts Group) decoding, for example, for the output of the input interface 12 and outputs the decoded results to the video signal processing section 16. The video signal processing section 16 performs processing such as resizing for the decoded results as required and outputs the resultant video signal processed results to the OSD superimposing section 18. The memory interface 26 is an interface between a work memory 24 and other components.

The work memory 24 is assumed to be external to the digital image processing device of FIG. 1, for example. Otherwise, the work memory 24 may be included in the digital image processing device of FIG. 1. The input video signal VIN may be a stream of another type or may be an analog signal. In the case of an analog signal, an A/D-converted signal will be supplied to the video signal processing section 16.

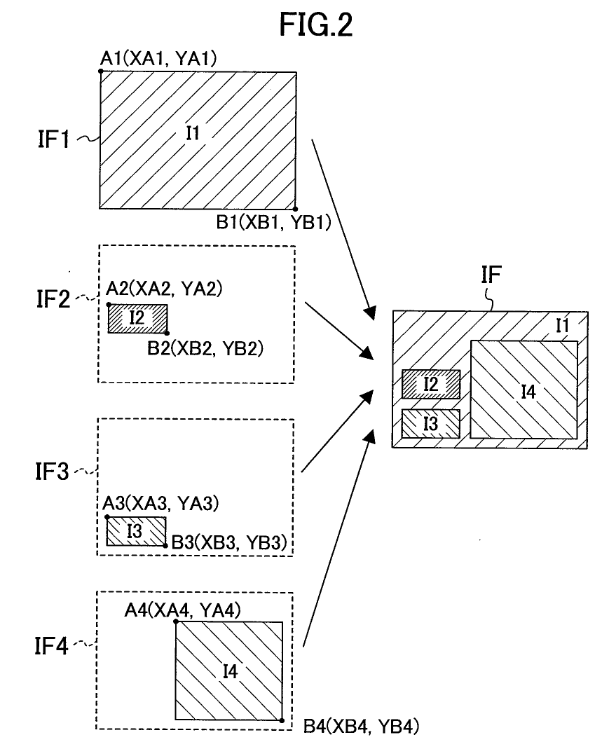

FIG. 2 is a view illustrating an example of OSD images represented by index data stored in the work memory 24 in FIG. 1. The work memory 24 is assumed to be able to store index data corresponding to frames IF1, IF2, IF3 and IF4. Assume herein that the size of each of the frames IF1, IF2, IF3 and IF4 is equal to the frame size of an output video signal VOUT, as an example.

The index data refers to data indicating any color in a palette having a small number of colors (2⁸ colors, for example) selected in advance from colors (2³² colors, for example) to be actually displayed. The colors to be actually displayed as used herein may be colors corresponding to the colors to be actually displayed. The colors selected and put in the palette are called index colors. Data indicating any of the colors to be actually displayed is called full-color data.

The palette is different among OSD images. Assume herein that the index data of each pixel is 8-bit data and corresponds to any of 2⁸ colors out of the 2³² colors, for example. In this case, each pixel can be represented by a color selected from the 2³² colors with eight bits, not 32 bits; hence the data amount for representing an image can be reduced.

The CPU 34 writes OSD images I1, I2, I3 and I4 in FIG. 2 each represented by index data into the work memory 24. The OSD image I1 covers a rectangular region whose diagonal is a line connecting point A1 and point B1 in the frame IF1. In the illustrated example, the rectangular region I1 is equivalent to the entire surface of the frame IF1. The OSD image I2 covers a rectangular region whose diagonal is a line connecting point A2 and point B2 in the frame IF2. The OSD image I3 covers a rectangular region whose diagonal is a line connecting point A3 and point B3 in the frame IF3. The OSD image I4 covers a rectangular region whose diagonal is a line connecting point A4 and point B4 in the frame IF4.

Priorities are assigned to the OSD images I1 to I4. Assume that the highest priority is given to the OSD image I4 and the priorities of the OSD images I3, I2 and I1 decrease in this order. FIG. 2 shows an example of display of an electronic program guide (EPG), in which the OSD image I1 represents the background, the OSD images I2 and I3 advertisement fields, and the OSD image I4 a TV program field.

The sequencer 32 reads the index data of the OSD images I1 to I4 from the work memory 24 and synthesizes the index data. In other words, the sequencer 32 overlays the OSD images I1 to I4 on one another considering the priorities of these OSD images and determines index data of the OSD image highest in priority for each pixel. For example, for a region in which the OSD image I1 and the OSD image I2 overlap, data of the OSD image I2 is adopted because the priority of the OSD image I2 is higher than the priority of the OSD image I1. As a result of synthesis of index data, index data of one frame like a synthesized image IF in FIG. 2 is obtained. The sequencer 32 writes the synthesized image IF into the work memory 24. The CPU 34 may otherwise perform this synthesis.

It is unnecessary to perform the synthesis of index data described above in synchronization with video output. The sequencer 32 and the CPU 34 can therefore perform the processing at any given timing. For example, the processing may be made during a time in which memory access is comparatively small, such as the vertical blanking interval, so that the effect of the synthesis on the memory bandwidth can be reduced.

The LUT memories 36 A to 36D respectively store lookup tables for the OSD images I1 to I4. Each of the lookup tables is a conversion table indicating the relationship between index data (8 bits, for example) and its corresponding full-color data (32 bits, for example) representing a color to be actually displayed, which has been written in advance by the CPU 34. The CPU 34 rewrites the lookup tables stored in the LUT memories 36A to 36D as required. Each of the LUT memories 36A to 36D implements its lookup table by storing a 32-bit value in each of 2⁸ addresses.

The OSD signal processing section 42 sequentially reads the index data of the synthesized image IF in FIG. 2 from the work memory 24. With the synthesized image IF being already prepared and stored in the work memory 24, arrangement can be made so as to read the index data from consecutive memory addresses, and this permits readout by burst transfer. The LUT memories 36A to 36D convert the read index data to full-color data representing colors to be actually displayed, and output the converted data to the multiplexer 38.

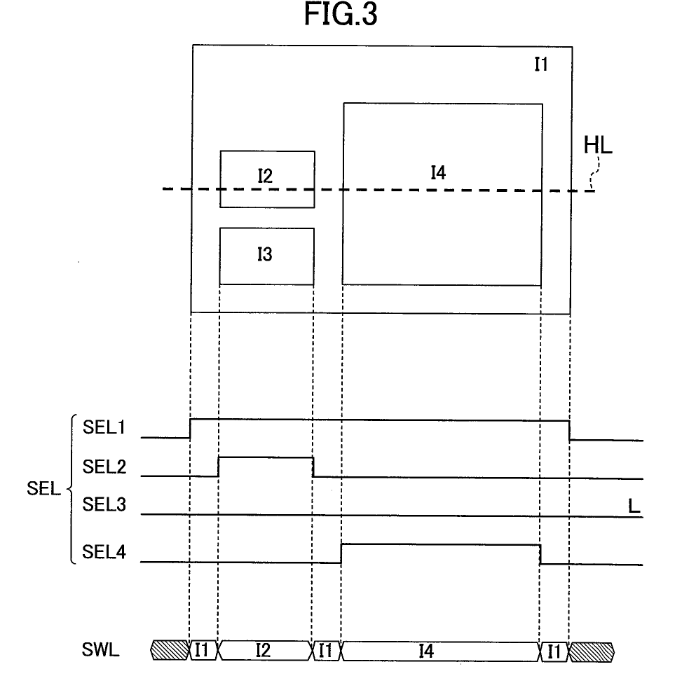

FIG. 3 is a view illustrating generation of an LUT switch signal SWL. Assume that the OSD signal processing section 42 reads the index data of the synthesized image IF in FIG. 2 from the work memory 24 under horizontal scanning. As an example, description will be made on index data along a horizontal line HL in FIG. 3. Assume that the OSD signal processing section 42 sequentially reads the index data of pixels on the horizontal line HL starting from the leftmost pixel toward the rightmost pixel. Once having read data on one line, the OSD signal processing section 42 then reads data on the next line. The region selection register 44 stores coordinate data indicating the regions in which the OSD images I1 to I4 are displayed; specifically, the coordinates (XA1, YA1) of point A1, the coordinates (XB1, YB1) of point B1, the coordinates (XA2, YA2) of point A2, the coordinates (XB2, YB2) of point B2, the coordinates (XA3, YA3) of point A3, the coordinates (XB3, YB3) of point B3, the coordinates (XA4, YA4) of point A4 and the coordinates (XB4, YB4) of point B4.

The region selection signal generation circuit 46 generates a selection signal SEL indicating whether or not the coordinates of pixels of the synthesized image IF are within respective regions of the OSD images I1 to I4. Specifically, the region selection signal generation circuit 46 puts a selection signal SEL1 in a high potential (“H”) during a time period corresponding to a section where the horizontal line HL and the OSD image I1 overlap based on the coordinate data of point A1 and point B1 stored in the region selection register 44. The region selection signal generation circuit 46 puts a selection signal SEL2 in “H” during a time period corresponding to a section where the horizontal line HL and the OSD image I2 overlap based on the coordinate data of point A2 and point B2 stored in the region selection register 44. The region selection signal generation circuit 46 keeps a selection signal SEL3 in a low potential (“L”) because the horizontal line HL and the OSD image I3 do not overlap. The region selection signal generation circuit 46 puts a selection signal SEL4 in “H” during a time period corresponding to a section where the horizontal line HL and the OSD image I4 overlap based on the coordinate data of point A4 and point B4 stored in the region selection register 44.

The region selection signal generation circuit 46, having received information indicating the coordinates of pixels of the read synthesized image IF from the OSD signal processing section 42, outputs the selection signals SEL1 to SEL4 in synchronization with the readout of the synthesized image IF. The region selection signal generation circuit 46 outputs the selection signals SEL1 to SEL4 to the decoder 48 as the selection signal SEL.

The decoder 48 generates the LUT switch signal SWL indicating the OSD image highest in priority, among the OSD images corresponding to any of the selection signals SEL1 to SEL4 whose level is “H”, based on the priorities of the OSD images I1 to I4, and outputs the resultant signal to the multiplexer 38. The LUT switch signal SWL indicates which one of the OSD images I1 to I4 should be displayed as a pixel of the synthesized image IF.

The multiplexer 38 selects the output of one of the LUT memories 36A to 36D that corresponds to the OSD image indicated by the LUT switch signal SWL, and outputs the selected results to the OSD signal processing section 42. Full-color data representing a color to be actually displayed is outputted from the multiplexer 38. In other words, the conversion section 35 converts the index data of the synthesized image read from the work memory to data representing their corresponding colors using the lookup table corresponding to the LUT switch signal SWL, and outputs the converted colors.

The OSD signal processing section 42 performs various types of signal processing such as resizing for the output of the multiplexer 38 and outputs the results to the OSD superimposing section 18. The OSD superimposing section 18 superimposes the output of the OSD signal processing section 42 on the output of the video signal processing section 16, and outputs the results to the output interface section 22. The output interface section 22 changes the output of the OSD superimposing section 18 to a signal of a desired type and outputs the results as the output video signal VOUT.

As described above, in the image processing device of FIG. 1, only index data of one frame are read from the work memory 24 irrespective of the number of OSD images superimposed on video. Hence, the data amount per unit time read from the work memory 24 during the video valid time period (time period other than the blanking interval), in particular, can be greatly reduced, and thus the latency at readout can be reduced.

In the above description, the four OSD images I1 to I4 were superimposed on video. A larger or smaller number of OSD images can also be superimposed easily in a similar manner.

The region selection register 44 does not necessarily store data indicating the regions of the OSD images over the entire display region (frame). A given LUT may be used for a region uncovered by the region selection register 44. Otherwise, fixed data may be outputted, or data stored in a separately placed register may be outputted, for such a region.

The LUT memories 36A to 36D may receive the LUT switch signal SWL, and only a memory among the LUT memories 36A to 36D that stores a lookup table used for the OSD image indicated by the LUT switch signal SWL may be configured to operate. In such a case where only the necessary memory operates, power consumption can be reduced.

The LUT memories 36A to 36D and the multiplexer 38 may be formed of one memory. In this case, by using the value of the LUT switch signal SWL as part of each address, selection of a lookup table to be used for conversion may be made with the LUT switch signal SWL.

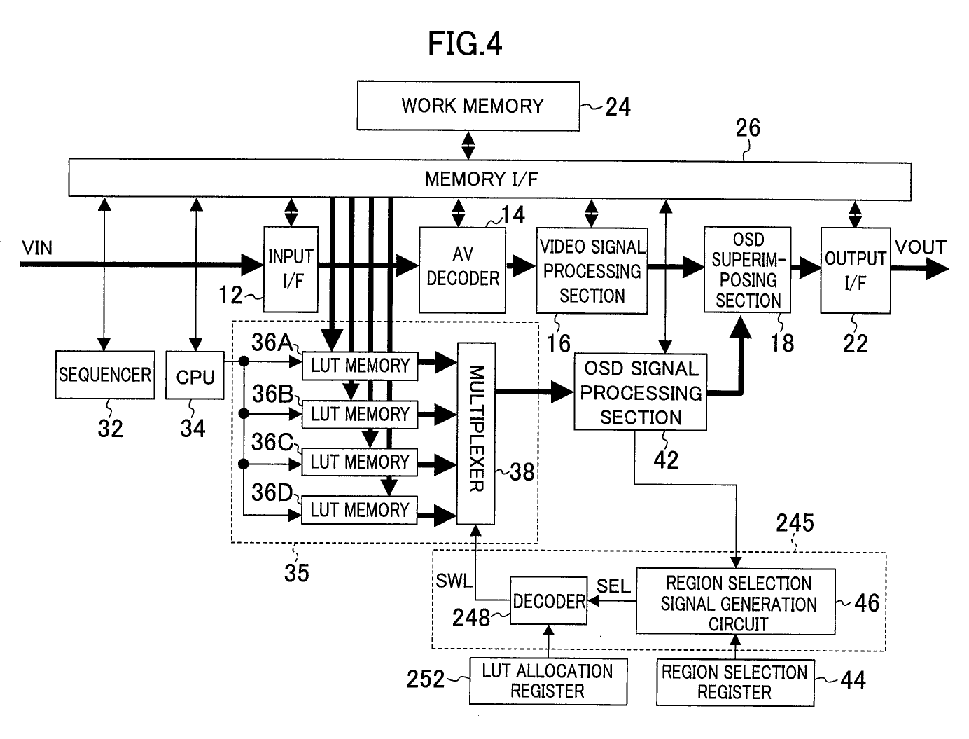

FIG. 4 is a block diagram of the first alteration of the digital image processing device of FIG. 1. The digital image processing device of FIG. 4 is different from the digital image processing device of FIG. 1 in further including a lookup table (LUT) allocation register 252 and including a decoder 248 in place of the decoder 48. The region selection signal generation circuit 46 and the decoder 248 constitute a switch signal generation section 245.

The LUT allocation register 252 stores allocation data indicating the relationship between the OSD images I1 to I4 and the lookup tables to be used for the individual OSD images. The decoder 248 determines the OSD image (any of the OSD images I1 to I4) to be displayed as a pixel of the synthesized image IF, like the decoder 48, and further generates a signal indicating a lookup table corresponding to the determined OSD image as the LUT switch signal SWL according to the allocation data.

The allocation data is written into the LUT allocation register 252 by the CPU 34 prior to the readout of the synthesized image IF. While the allocation of the lookup tables to the OSD images I1 to I4 was fixed in the digital image processing device of FIG. 1, it can be easily changed by rewriting the allocation data in the digital image processing device of FIG. 4.

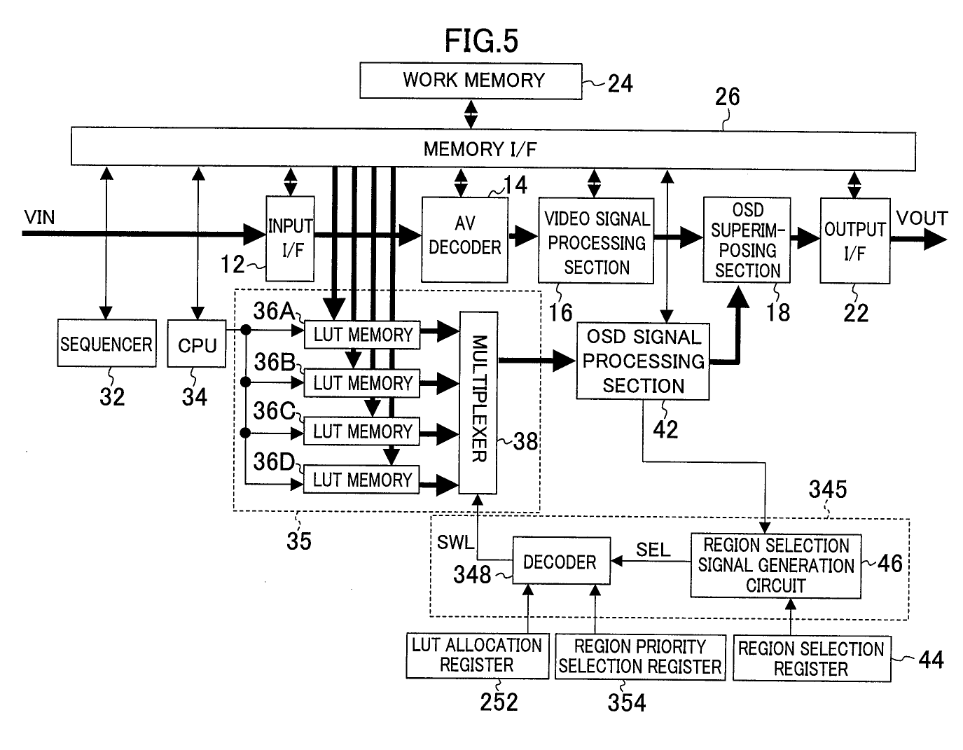

FIG. 5 is a block diagram of the second alteration of the digital image processing device of FIG. 1. The digital image processing device of FIG. 5 is different from the digital image processing device of FIG. 4 in further including a region priority selection register 354 and including a decoder 348 in place of the decoder 248. The region selection signal generation circuit 46 and the decoder 348 constitute a switch signal generation section 345.

The region priority selection register 354 stores the priorities of the OSD images I1 to I4. The decoder 348 operates the same as the decoder 248 except for performing the processing according to the priorities stored in the region priority selection register 354.

The priorities are written in the region priority selection register 354 by the CPU 34 prior to the readout of the synthesized image IF. The CPU 34 also informs the sequencer 32 of the same priorities. In the digital image processing device of FIG. 4, in changing the priorities of the OSD images I1 to I4 in display, it was necessary to change the data stored in the region selection register 44 and the LUT allocation register 252 simultaneously. In the digital image processing device of FIG. 5, however, the priorities of the OSD images I1 to I4 in display can be easily changed by only rewriting the priorities stored in the region priority selection register 354.

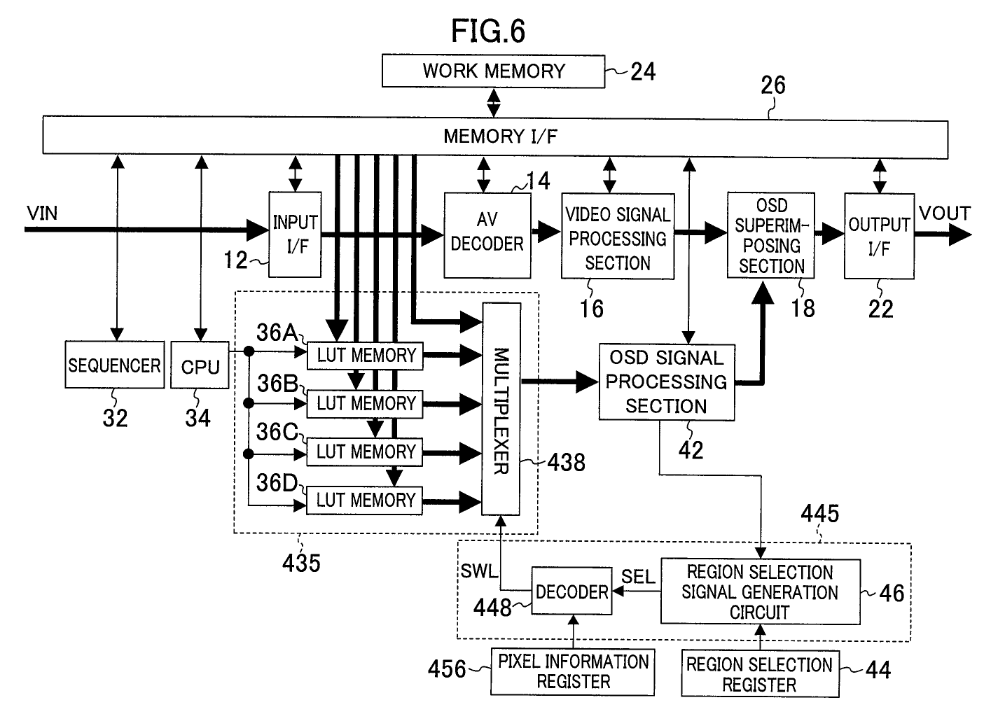

FIG. 6 is a block diagram of the third alteration of the digital image processing device of FIG. 1. The digital image processing device of FIG. 6 is different from the digital image processing device of FIG. 1 in further including a pixel information register 456 and including a multiplexer 438 and a decoder 448 in place of the multiplexer 38 and the decoder 48. The LUT memories 36A to 36D and the multiplexer 438 constitute a conversion section 435, and the region selection signal generation circuit 46 and the decoder 448 constitute a switch signal generation section 445. The digital image processing device of FIG. 6 processes an OSD image I5 composed of full-color data in place of the OSD image I4 composed of index data.

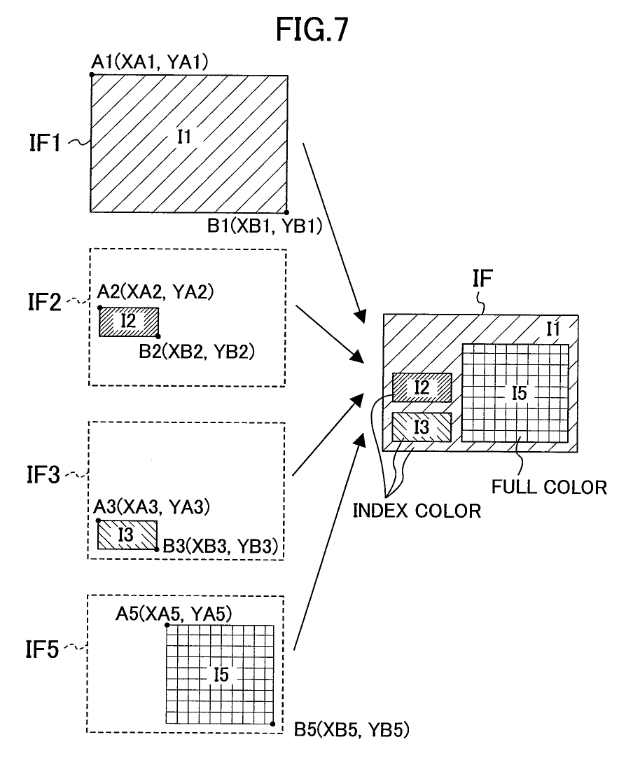

FIG. 7 is a view illustrating an example of OSD images stored in the work memory 24 in FIG. 6. The work memory 24 is assumed to be able to store index data corresponding to the frames IF1, IF2 and IF3 and full-color data corresponding to the frame IF5. Assume herein that the size of the frame IF5 is equal to the frame size of the output video signal VOUT, as an example.

The CPU 34 writes the OSD images I1, I2, I3 and I5 in FIG. 7 into the work memory 24. Assume that the OSD images I1, I2 and I3 are the same as those shown in FIG. 2. The OSD image I5 covers a rectangular region whose diagonal is a line connecting point A5 (XA5, YA5) and point B5 (XB5, YB5) in the frame IF5. The OSD images I1 to I3 are represented by index data, and the OSD image I5 is represented by full-color data. Assume that the highest priority is given to the OSD image I5 and the priorities of the OSD images I3, I2 and I1 decrease in this order.

The sequencer 32 reads the index data of the OSD images I1 to I3 and the full-color data of the OSD image I5 from the work memory 24, and synthesizes the data. In other words, the sequencer 32 overlays the OSD images I1 to I3 and I5 on one another considering the priorities of these OSD images and determines data of the OSD image highest in priority for each pixel. As a result of synthesis of data, data of one frame like a synthesized image IF in FIG. 7 is obtained. The sequencer 32 writes the synthesized image IF into the work memory 24. The CPU 34 may otherwise perform this synthesis.

In the pixel information register 456, pixel information indicating which data, index data representing an index color or full-color data representing a color to be displayed, each of the OSD images I1 to I3 and I5 is composed of is stored by the CPU 34 prior to the readout of the synthesized image IF. The decoder 448, like the decoder 48, determines the switch signal SWL indicating the OSD image (any of the OSD images I1 to I3 and I5) to be displayed as a pixel of the synthesized image IF. Further, if a pixel of the OSD image I5 is to be displayed as a pixel of the synthesized image IF, the decoder 448 generates the switch signal SWL for instructing the multiplexer 38 to output data read from the work memory 24 as it is according to the pixel information in the pixel information register 456.

In the digital image processing device of FIG. 6, an OSD image for which detailed rendering is desired, like display of a natural image and a data broadcast, may be prepared with full-color data, and an OSD image that can be expressed with only a comparative small number of colors, like display of subtitles, may be prepared with index data. With this, display with smoother gradation can be attained compared with the case of preparing OSD images with only index data.

In any of the digital image processing devices described above, the synthesized image IF is first prepared and stored in the work memory 24 and then read out. Hence, unlike the case of synthesizing an image while reading the OSD image I1 and the like, it is unnecessary to transfer data for a non-displayed region. Also, since the synthesized image IF can be stored in consecutive addresses in the work memory 24, efficient readout by burst transfer is permitted.

### INDUSTRIAL APPLICABILITY

As described above, according to an exemplary embodiment of the present invention, the data amount per unit time read from the work memory can be reduced. The present invention is therefore useful for digital image processing devices and the like.

1. A digital image processing device comprising:
a sequencer configured to overlay a plurality of on screen display (OSD) images on each other considering their priorities and store a resultant synthesized image in a work memory;
a switch signal generation section configured to generate a switch signal indicating which pixel among pixels of the plurality of OSD images should be displayed as a pixel of the synthesized image based on coordinate data indicating regions in which the plurality of OSD images are displayed and the priorities of the plurality of OSD images; and
a conversion section configured to store lookup tables each indicating the relationship between index data and data representing a color corresponding to the index data, convert index data of the synthesized image read from the work memory to data representing a corresponding color using the lookup table corresponding to the switch signal, and output the resultant data.

2. The digital image processing device of claim 1, wherein the switch signal generation section includes:
a region selection signal generation circuit configured to generate a selection signal indicating whether the coordinates of a pixel of the synthesized image are within respective regions of the plurality of OSD images based on the coordinate data; and
a decoder configured to generate the switch signal based on the priorities of the plurality of OSD images and the selection signal.

3. The digital image processing device of claim 1, further comprising:
a region selection register configured to store the coordinate data.

4. The digital image processing device of claim 1, further comprising:
a lookup table allocation register configured to store allocation data indicating the relationship between the plurality of OSD images and the lookup tables to be used for the OSD images,
wherein the switch signal generation section generates, as the switch signal according to the allocation data, a signal indicating the lookup table corresponding to the OSD image to be displayed as a pixel of the synthesized image.

5. The digital image processing device of claim 1, further comprising:
a region priority selection register configured to store the priorities of the plurality of OSD images,
wherein the switch signal generation section performs processing according to the priorities stored in the region priority selection register.

6. The digital image processing device of claim 1, further comprising:
a pixel information register configured to store pixel information indicating which data, index data or full-color data, each of the plurality of OSD images is composed of,
wherein the switch signal generation section generates the switch signal according to the pixel information so that for the OSD image composed of full-color data, the conversion section outputs data of the synthesized image read from the work memory without conversion.
